(19) United States
(12) Patent Application Publication
(10) Pub. No.: US 2018/0180021 A1
(43) Pub. Date: Jun. 28, 2018

(54) WIND HARNESSING DEVICE

(71) Applicant: SHIH-YU HUANG, New Taipei City (TW)

(72) Inventor: SHIH-YU HUANG, New Taipei City (TW)

(21) Appl. No.: 15/790,065

(22) Filed: Oct. 23, 2017

(30) Foreign Application Priority Data
Dec. 28, 2016 (TW) 105219850

(51) Int. Cl. F03D 3/06

(52) U.S. Cl. CPC F03D 3/067; F03D 3/002

(57) ABSTRACT

The wind harnessing device includes an axle, a number of radially outward extending first and second poles respectively arranged at equal intervals around a first end and a second end of the axle, a number of blade assemblies, and a rack to which the axle is rotatably mounted. Each first pole is aligned with and parallel to a second pole. Each blade assembly includes a first beam, a second beam, and a flat blade. The first and second beams are respectively attached to and along a first edge and an opposite second edge of the blade. The first beam's two ends are pin joined to the outer ends of a pair of corresponding first and second poles so that the blade is able to swing about the first beam. The wind harnessing device thus structured is of lower weight, reduced cost, and easy maintenance.

### BACKGROUND OF THE INVENTION

### (a) Technical Field of the Invention

The present invention generally relates to the harness of wind power, and more particularly to a wind harnessing devices of lower weight, enhanced efficiency, reduced cost, and easy maintenance.

### (b) Description of the Prior Art

A conventional wind harnessing device has a number of blades rotating about an axle. These blades are usually solid and made of metallic or composite materials. The blades are therefore quite heavy and a greater wind power is required to propel them. The heavy weight also leads to more difficult repair and maintenance.

In addition, the blades are configured at fixed angles to the axle. When wind is not blown directly towards the blades, the blades' angles cannot be adjusted to harness as much wind power as possible, but introduce greater friction, thereby compromising the generator efficiency.

### SUMMARY OF THE INVENTION

Therefore a major objective of the present invention is to provide a wind harnessing device of lower weight, enhanced efficiency, reduced cost, and easy maintenance.

The wind harnessing device includes an axle, a number of radially outward extending first and second poles respectively arranged at equal intervals around a first end and a second end of the axle, a number of blade assemblies, and a rack to which the axle is rotatably mounted. Each first pole is aligned with and parallel to a second pole. Each blade assembly includes a first beam, a second beam, and a flat blade. The first and second beams are respectively attached to and along a first edge and an opposite second edge of the blade. The first beam's two ends are pin joined to the outer ends of a pair of corresponding first and second poles so that the blade is able to swing about the first beam. The wind harnessing device thus structured is of lower weight, reduced cost, and easy maintenance.

The wind harnessing device further includes at least a steering board configured on the rack perpendicular to ground, and a pedestal supporting the rack so that the rack is able to swivel on the pedestal.

A brake device is connected to an end of the axle for braking the axle; and a power delivery unit is connected to another end of the axle for delivering power converted from wind energy by the wind harnessing device.

Each blade is made of canvas, plastics, or metal.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a wind harnessing device according to an embodiment of the present invention.

FIG. 2 is another perspective diagram showing the wind harnessing device of FIG. 1.

FIG. 3 is a perspective diagram showing an operation scenario of the wind harnessing device of FIG. 1.

FIG. 4 is a perspective diagram showing a wind harnessing device according to another embodiment of the present invention.

### DETAILED DESCRIPTION OF THE PREFERRED EMBODIMENTS

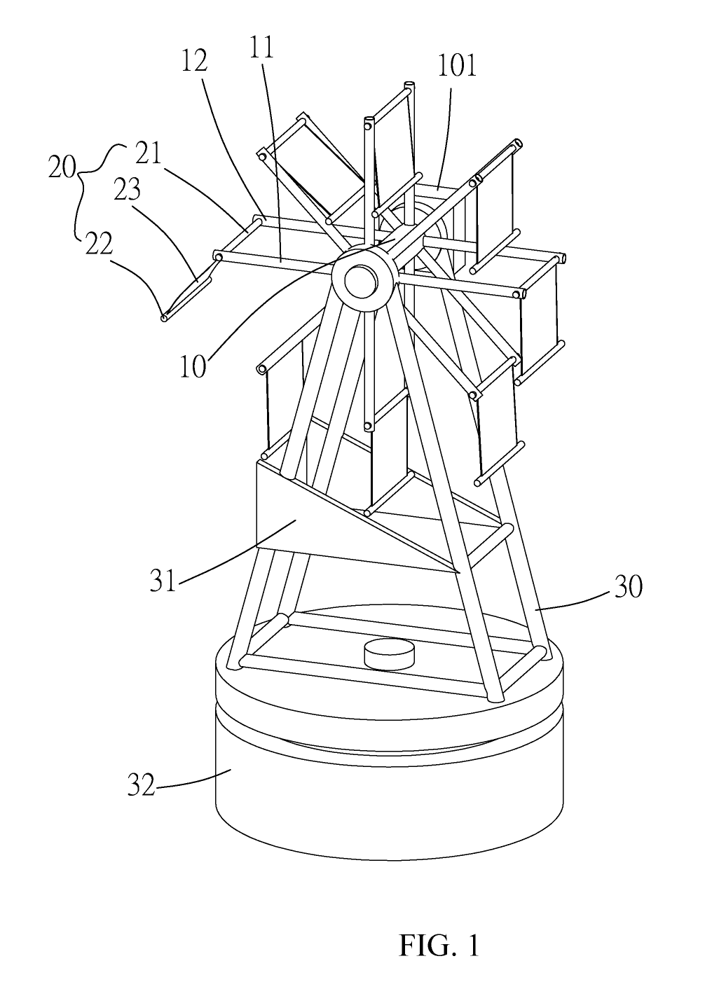

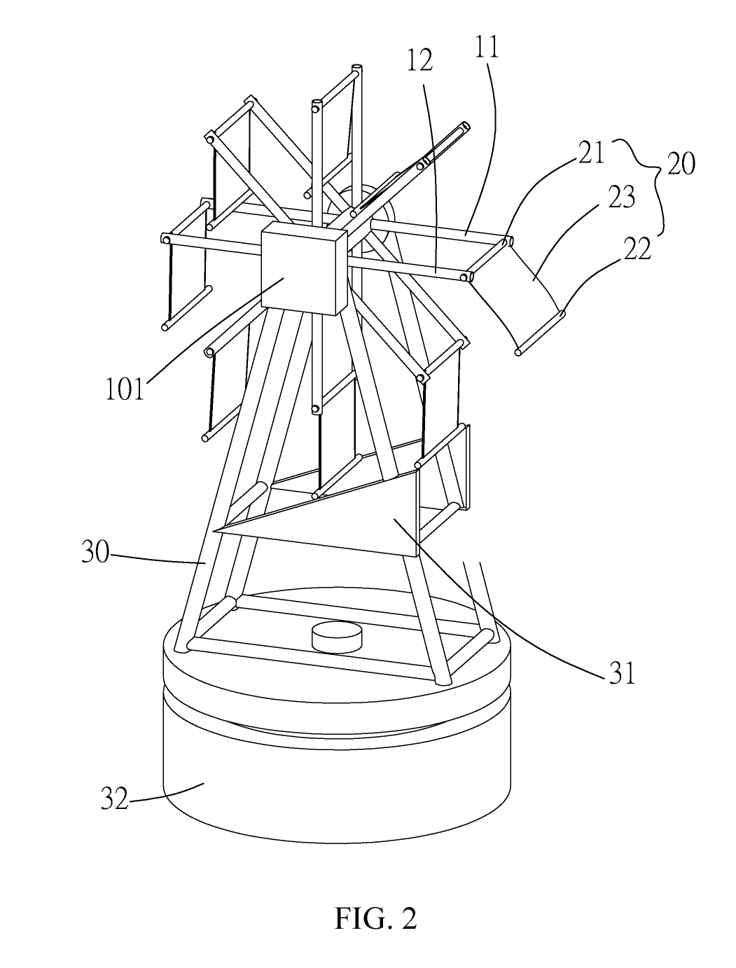

As shown in FIGS. 1 and 2, a wind harnessing device according to an embodiment of the present invention includes an axle 10, a number of radially outward extending first poles 11 arranged at equal intervals around a first end of the axle 10, and a number of radially outward extending second poles 12 arranged at equal intervals around a second end of the axle 10. Each first pole 11 is aligned with and parallel to a second pole 12. The wind harnessing device further includes a number of blade assemblies 20, each including a first beam 21, a second beam 22, and a flat blade 23. The first beam 21 is attached to and along a first edge of the blade 23, and the second beam 22 is attached to and along a second edge of the blade 23 opposite to the first edge. The first beam 21′s two ends are pin-joined to the outer ends of a pair of corresponding first and second poles 11 and 12. Therefore the blade 23 may swing about the first beam 21. The wind harnessing device further includes a rack 30 to which the axle 10 is rotatably mounted. The simplified structure as described above provides lower weight, recued cost, and easy maintenance.

As illustrated, when the wind harnessing device is not engaged by wind, under gravity, each blade assembly 20 would be perpendicular to ground. Each blade 23 is made of canvas, plastics, or metal. The rack 30 support the weight of the axle 10, the first and second poles 11 and 12, and the blade assemblies 20. At least a steering board 31 perpendicular to ground is configured on the rack 30. The rack 30 is mounted on a pedestal 32 so that the rack 30 may swivel on the pedestal 32. The second end of the axle 10 may be connected to a brake device 101 to stop the axle 10 from spinning

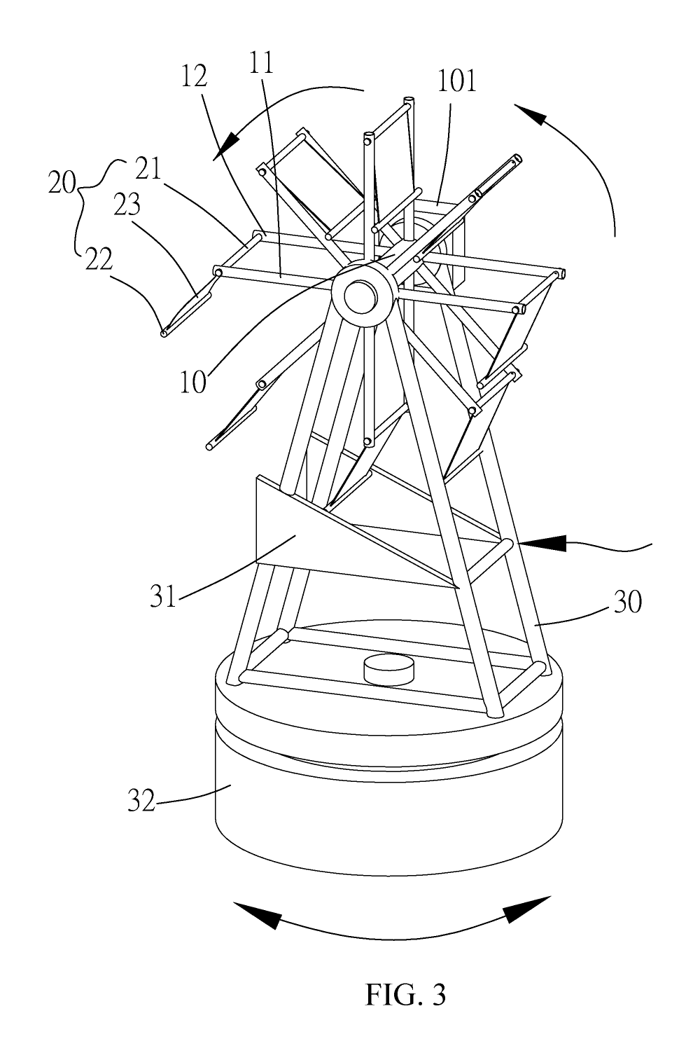

As shown in FIG. 3, when wind engages the wind harnessing device, the steering board 31 causes the wind harnessing device to swivel on the pedestal 32 so that the steering board 31 would be parallel to the wind direction. As such, the blade assemblies 20 would meet the wind head-on, and propelled by the wind. As the first beam 21 of each blade assembly 20 is pin-joined to a pair of first and second poles 11 and 12, each blade 23 would swing along the wind and form an angle with ground and, the stronger the wind, the greater the angle. Please note that the second beam 22 has a length larger than the distance between the first and second poles 11 and 12. Each blade 23 is made of a lightweight material such as canvas so that it will swing easily with a mind wind, and its swing reduce friction to the wind, thereby enhancing the wind harnessing device's efficiency. When the second beam 22 presses the first and second poles 11 and 22 by the wind, the first and second poles 11 and 12 in turn drive the axle 10 to spin. To stop the wind harnessing device 10, the brake device 101 may be activated to apply a brake on the axle 10. As described above, the axle 10 of the wind harnessing device is rotated by wind's driving on the blade assemblies 20 that are dangled between pairs of first and second poles 11 and 12.

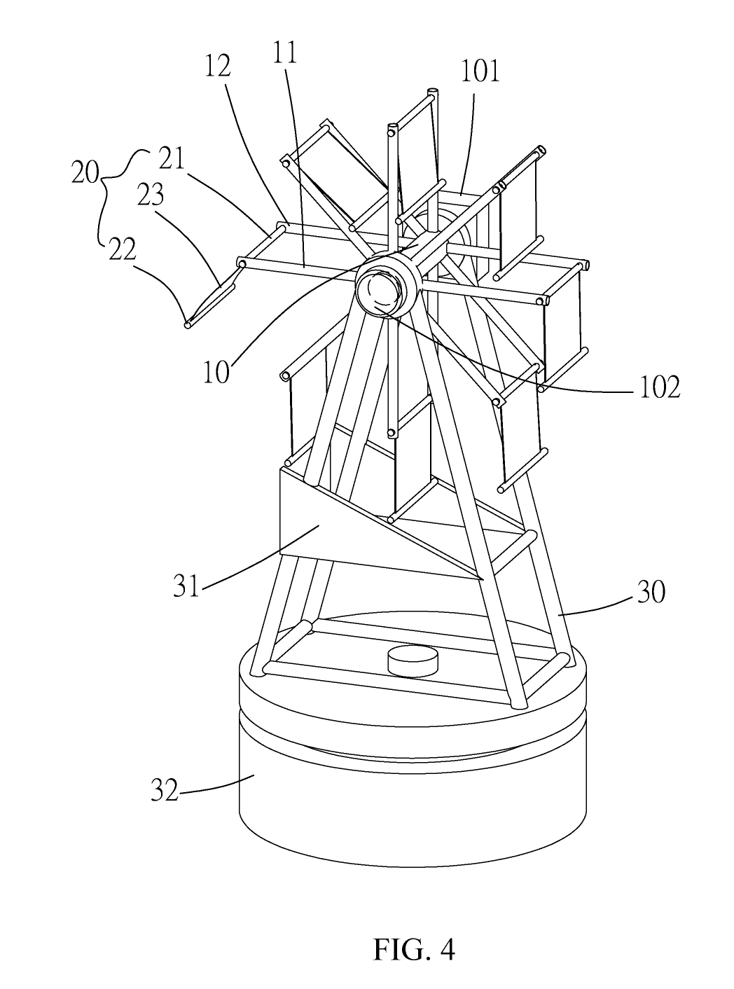

As shown in FIG. 4, a wind harnessing device according to another embodiment of the present invention has, in addition to the brake device 101 connected to the second end of the axle 10, a power delivery unit 102 connected the first end of the axle 10 for delivering power (e.g., electrical power) converted from wind energy and the kinetic energy of the axle 10 by the wind harnessing device.

I claim:

1. A wind harnessing device, comprising
an axle;
a plurality of radially outward extending first poles arranged at equal intervals around a first end of the axle;
a plurality of radially outward extending second poles arranged at equal intervals around a second end of the axle, where each first pole is aligned with and parallel to a second pole;
a plurality of blade assemblies, each comprising a first beam, a second beam, and a flat blade, where the first beam is attached to and along a first edge of the blade, the second beam is attached to and along a second edge of the blade opposite to the first edge, the first beam's two ends are pin joined to the outer ends of a pair of corresponding first and second poles so that the blade is able to swing about the first beam; and
a rack to which the axle is rotatably mounted.

2. The wind harnessing device according to claim 1, further comprising at least a steering board configured on the rack perpendicular to ground, and a pedestal supporting the rack so that the rack is able to swivel on the pedestal.

3. The wind harnessing device according to claim 1, wherein a brake device is connected to an end of the axle for braking the axle; and a power delivery unit is connected to another end of the axle for delivering power converted from wind energy by the wind harnessing device.

4. The wind harnessing device according to claim 1, wherein each blade is made of canvas, plastics, or metal.
